(19) United States
(12) Patent Application Publication
(10) Pub. No.: US 2025/0081076 A1
(43) Pub. Date: Mar. 6, 2025

(54) METHODS AND APPARATUSES FOR MOBILITY ENHANCEMENTS FOR UAV

(71) Applicant: LENOVO (BEIJING) LIMITED, Beijing (CN)

(72) Inventors: Le YAN, Shanghai (CN); Jing HAN, Beijing (CN); Lianhai WU, Beijing (CN); Mingzeng DAI, Shanghai (CN); Yibin ZHUO, Shanghai (CN); Congchi ZHANG, Shanghai (CN)

(21) Appl. No.: 18/724,828

(22) PCT Filed: Dec. 28, 2021
(86) PCT No.: PCT/CN2021/142046

§ 371 Date: Jun. 27, 2024

(51) Int. Cl. H04W 36/36; H04W 36/32

(52) U.S. Cl. CPC H04W 36/362; H04W 36/324; H04W 36/328

(57) ABSTRACT

Embodiments of the present application relate to methods and apparatuses for mobility enhancements for an unmanned aerial vehicle (UAV). According to an embodiment of the present application, a user equipment (UE) includes a processor and a transceiver coupled to the processor; and the processor is configured: to receive, via the transceiver, configuration information of a conditional handover (CHO) procedure regarding at least one of a height based condition or a flight path based condition; to evaluate whether at least one execution condition for at least one candidate cell of the CHO procedure is satisfied, wherein the at least one execution condition includes the at least one of the height based condition or the flight path based condition; and to execute the CHO procedure upon the at least one execution condition being satisfied.

### TECHNICAL FIELD

Embodiments of the present application generally relate to wireless communication technology, in particular to methods and apparatuses for mobility enhancements for an unmanned aerial vehicle (UAV).

### BACKGROUND

A base station (BS) can have some cells (or areas) to provide communication service. When a user equipment (UE) moves from a serving cell (or source cell) of a source BS to a target cell of a target BS, a handover procedure is performed. When a radio link failure (RLF) or a handover (HO) failure occurs for a UE, the UE may perform a radio resource control (RRC) re-establishment procedure. The UE may access a cell by a successful RRC re-establishment procedure. The accessed network will request UE information including a RLF-report of the UE if the UE indicates the network that it has stored or logged the UE information including a RLF-report, such that the network can optimize the mobility problem based on the UE information from the UE. Accordingly, the UE will transmit a failure report to the network.

A MRO mechanism is to detect connection failure(s) that occur due to Too Early or Too Late Handovers, or Handover to Wrong Cell. The general procedure is that after a RLF or a HO failure happens, a UE access a new cell by RRC re-establishment or connection setup procedure. Once the UE enters a connected state, the UE transmits a RLF-report and/or a random access channel (RACH) report to the serving cell. The serving cell will transmit a failure indication including the RLF-report to the last serving cell. Finally, the information is used to optimize the mobility.

For UAV, at different heights, the cell deployment may be different. For example, the UE flying at one height can see more neighbor cells compared to when it is on the ground. Therefore, for the same cell, it may provide different coverage or capacity at different height. Currently, details regarding mobility enhancements for an UAV have not been discussed in 3GPP 5G technology yet.

### SUMMARY

Some embodiments of the present application also provide a UE. The UE includes a processor and a transceiver coupled to the processor; and the processor is configured: to receive, via the transceiver, configuration information of a conditional handover (CHO) procedure regarding at least one of a height based condition or a flight path based condition; to evaluate whether at least one execution condition for at least one candidate cell of the CHO procedure is satisfied, wherein the at least one execution condition includes the at least one of the height based condition or the flight path based condition; and to execute the CHO procedure upon the at least one execution condition being satisfied.

Some embodiments of the present application provide a method, which may be performed by a UE. The method includes: receiving configuration information of a CHO procedure regarding at least one of a height based condition or a flight path based condition; and evaluating whether at least one execution condition for at least one candidate cell of the CHO procedure is satisfied, wherein the at least one execution condition includes the at least one of the height based condition or the flight path based condition; and executing the CHO procedure upon the at least one execution condition being satisfied.

Some embodiments of the present application also provide an apparatus for wireless communications. The apparatus includes: a non-transitory computer-readable medium having stored thereon computer-executable instructions; a receiving circuitry; a transmitting circuitry; and a processor coupled to the non-transitory computer-readable medium, the receiving circuitry and the transmitting circuitry, wherein the computer-executable instructions cause the processor to implement the above-mentioned method performed by a UE.

Some embodiments of the present application also provide a source network node (e.g., a source BS). The source network node includes a processor and a transceiver coupled to the processor; and the processor is configured: to generate configuration information regarding at least one execution condition for at least one candidate cell of a CHO procedure of a UE, wherein the at least one execution condition includes at least one of a height based condition or a flight path based condition; and to transmit the configuration information via the transceiver to the UE.

Some embodiments of the present application provide a method, which may be performed by a source network node (e.g., a source BS that manages a source cell or serving cell). The method includes: generating configuration information regarding at least one execution condition for at least one candidate cell of a CHO procedure of a UE, wherein the at least one execution condition includes at least one of a height based condition or a flight path based condition; and transmitting the configuration information via the transceiver to the UE.

Some embodiments of the present application provide an apparatus. The apparatus includes: a non-transitory computer-readable medium having stored thereon computer-executable instructions, a receiving circuitry; a transmitting circuitry; and a processor coupled to the non-transitory computer-readable medium, the receiving circuitry and the transmitting circuitry, wherein the computer-executable instructions cause the processor to implement the abovementioned method performed by a source network node (e.g., a source BS that manages a source cell or serving cell).

Some embodiments of the present application also provide a network node (e.g., a candidate BS that manages at least one candidate cell of a conditional handover (CHO) procedure or a target BS that manages a target cell of a CHO procedure). The network node includes a processor and a transceiver coupled to the processor; and the processor is configured: to transmit a height based neighbour cell list of the network node via the transceiver to a source network node of a UE and to receive a further height based neighbour cell list of the source network node via the transceiver from the source network node; or to receive an indication via the transceiver from the source network node, wherein the indication indicates the network node to generate information regarding at least one execution condition for at least one candidate cell of a CHO procedure of the UE, wherein the at least one execution condition includes at least one of a height based condition or a flight path based condition.

Some embodiments of the present application provide a method, which may be performed by a network node (e.g., a candidate BS that manages at least one candidate cell of a conditional handover (CHO) procedure or a target BS that manages a target cell of a CHO procedure). The method includes: transmitting a height based neighbour cell list of the network node to a source network node of a UE and receiving a further height based neighbour cell list of the source network node from the source network node; or receiving an indication from the source network node, wherein the indication indicates the network node to generate information regarding at least one execution condition for at least one candidate cell of a CHO procedure of the UE, wherein the at least one execution condition includes at least one of a height based condition or a flight path based condition.

Some embodiments of the present application provide an apparatus. The apparatus includes: a non-transitory computer-readable medium having stored thereon computer-executable instructions, a receiving circuitry; a transmitting circuitry; and a processor coupled to the non-transitory computer-readable medium, the receiving circuitry and the transmitting circuitry, wherein the computer-executable instructions cause the processor to implement the abovementioned method performed by a network node (e.g., a candidate BS that manages at least one candidate cell of a conditional handover (CHO) procedure or a target BS that manages a target cell of a CHO procedure).

The details of one or more examples are set forth in the accompanying drawings and the descriptions below. Other features, objects, and advantages will be apparent from the descriptions and drawings, and from the claims.

### BRIEF DESCRIPTION OF THE DRAWINGS

In order to describe the manner in which advantages and features of the application can be obtained, a description of the application is rendered by reference to specific embodiments thereof, which are illustrated in the appended drawings. These drawings depict only example embodiments of the application and are not therefore to be considered limiting of its scope.

FIG. 1 illustrates a schematic diagram of a wireless communication system in accordance with some embodiments of the present application.

FIG. 2 illustrates an exemplary block diagram of an apparatus according to some embodiments of the present application.

FIG. 3 illustrates a flowchart of executing a CHO procedure according to some embodiments of the present application.

FIG. 4 illustrates a flow chart of transmitting configuration information according to some embodiments of the present application.

### DETAILED DESCRIPTION

The detailed description of the appended drawings is intended as a description of preferred embodiments of the present application and is not intended to represent the only form in which the present application may be practiced. It should be understood that the same or equivalent functions may be accomplished by different embodiments that are intended to be encompassed within the spirit and scope of the present application.

Reference will now be made in detail to some embodiments of the present application, examples of which are illustrated in the accompanying drawings. To facilitate understanding, embodiments are provided under specific network architecture and new service scenarios, such as 3rd Generation Partnership Project (3GPP) LTE and LTE advanced, 3GPP 5G NR, 5G-Advanced, 6G, and so on. It is contemplated that along with developments of network architectures and new service scenarios, all embodiments in the present application are also applicable to similar technical problems; and moreover, the terminologies recited in the present application may change, which should not affect the principle of the present application.

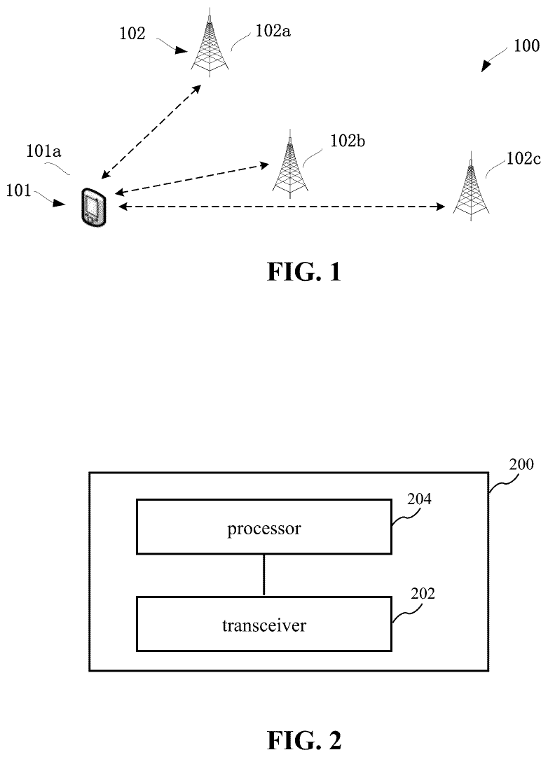

FIG. 1 illustrates a schematic diagram of a wireless communication system in accordance with some embodiments of the present application.

As illustrated and shown in FIG. 1, a wireless communication system 100 includes at least one UE 101 and at least one BS 102. In particular, the wireless communication system 100 includes one UE 101 (e.g., UE 101a) and three BSs 102 (e.g., BS 102a, BS 102b, and BS 102c) for illustrative purpose. Although a specific number of UEs 101 and BSs 102 are depicted in FIG. 1, it is contemplated that any number of UEs 101 and BSs 102 may be included in the wireless communication system 100.

UE(s) 101 may include computing devices, such as desktop computers, laptop computers, personal digital assistants (PDAs), tablet computers, smart televisions (e.g., televisions connected to the Internet), set-top boxes, game consoles, security systems (including security cameras), vehicle on-board computers, network devices (e.g., routers, switches, and modems), internet of things (IoT) devices, or the like. According to some embodiments of the present application, UE(s) 101 may include a portable wireless communication device, a smart phone, a cellular telephone, a flip phone, a device having a subscriber identity module, a personal computer, a selective call receiver, or any other device that is capable of transmitting and receiving communication signals on a wireless network. In some embodiments of the present application, UE(s) 101 includes wearable devices, such as smart watches, fitness bands, optical head-mounted displays, or the like. Moreover, UE(s) 101 may be referred to as a subscriber unit, a mobile, a mobile station, a user, a terminal, a mobile terminal, a wireless terminal, a fixed terminal, a subscriber station, a user terminal, or a device, or described using other terminology used in the art. UE(s) 101 may communicate directly with BSs 102 via uplink (UL) communication signals.

In some embodiments of the present application, each of UE(s) 101 may be deployed an IoT application, an eMBB application and/or an URLLC application. It is contemplated that the specific type of application(s) deployed in UE(s) 101 may be varied and not limited.

BS(s) 102 may be distributed over a geographic region. In certain embodiments of the present application, each of BS(s) 102 may also be referred to as an access point, an access terminal, a base, a base unit, a macro cell, a Node-B, an evolved Node B (eNB), a gNB, a NG-RAN (Next Generation-Radio Access Network) node, a Home Node-B, a relay node, or a device, or described using other terminology used in the art. BS(s) 102 is generally a part of a radio access network that may include one or more controllers communicably coupled to one or more corresponding BS(s) 102.

The wireless communication system 100 may be compatible with any type of network that is capable of transmitting and receiving wireless communication signals. For example, the wireless communication system 100 is compatible with a wireless communication network, a cellular telephone network, a Time Division Multiple Access (TDMA)-based network, a Code Division Multiple Access (CDMA)-based network, an Orthogonal Frequency Division Multiple Access (OFDMA)-based network, an LTE network, a 3GPP-based network, a 3GPP 5G network, a satellite communications network, a high altitude platform network, and/or other communications networks.

In some embodiments of the present application, the wireless communication system 100 is compatible with the 5G of the 3GPP protocol, wherein BS(s) 102 transmit data using an OFDM modulation scheme on the downlink (DL) and UE(s) 101 transmit data on the UL using a single-carrier frequency division multiple access (SC-FDMA) or OFDM scheme. More generally, however, the wireless communication system 100 may implement some other open or proprietary communication protocols, for example, WiMAX, among other protocols.

In some embodiments of the present application, BS(s) 102 may communicate using other communication protocols, such as the IEEE 802.11 family of wireless communication protocols. Further, in some embodiments of the present application, BS(s) 102 may communicate over licensed spectrums, whereas in other embodiments, BS(s) 102 may communicate over unlicensed spectrums. The present application is not intended to be limited to the implementation of any particular wireless communication system architecture or protocol. In yet some embodiments of present application, BS(s) 102 may communicate with UE(s) 101 using the 3GPP 5G protocols.

Each BS(s) 102 may include one or more cells. Each UE(s) 101 may perform a handover procedure or a cell reselection procedure between different cell(s) of different BS(s). Each UE(s) 101 with a RRC-connected state may handover from a serving cell or a source cell of a source BS to a target cell of a target BS. For example, in the wireless communication system 100 as illustrated and shown in FIG. 1, BS 102a may function as a source BS, and each of BS 102b and BS 102c may function as a target BS. If there is a handover need, UE 101a as illustrated and shown in FIG. 1 may perform a handover procedure from a serving cell of BS 102a to a target cell of BS 102b or a target cell of BS 102c. The handover procedure performed by UE 101a may be a traditional handover procedure or a CHO procedure.

As specified in 3GPP standard documents, a CHO procedure is defined as a handover that is executed by a UE when one or more handover execution conditions are met. The UE starts evaluating the execution condition(s) upon receiving the CHO configuration, and stops evaluating the execution condition(s) once a handover is executed (the execution condition(s) is met).

As specified in 3GPP standard documents, following principles apply to a CHO procedure.
The CHO configuration contains the configuration of CHO candidate cell(s) generated by the candidate BS and execution condition(s) generated by a source BS.
An execution condition may consist of one or two trigger condition(s) (e.g., radio resource management (RRM) based condition like CondEvent A3, CondEvent A4, or CondEvent A5). Only single reference signal (RS) type is supported and at most two different trigger quantities (e.g., reference signal received power (RSRP) and reference signal received quality (RSRQ), RSRP and signal to interference plus noise ratio (SINR), etc.) can be configured simultaneously for the evalution of CHO execution condition of a single candidate cell.
Before any CHO execution condition is satisfied, upon reception of a HO command (without CHO configuration), the UE executes the traditional HO procedure, regardless of any previously received CHO configuration.
While executing CHO, i.e., from the time when the UE starts synchronization with a target cell, the UE does not monitor a source cell.

Regarding a radio resource management (RRM) based condition, in NR system, 3GPP TS38.331 defines CondEvent A3, CondEvent A4, and CondEvent A5 and their entering conditions and leaving conditions, respectively, as below. In EUTRAN system, 3GPP TS386.331 defines CondEvent A3, CondEvent A4, and CondEvent A5, and the details can be referred to 3GPP TS386.331.
1) CondEvent A3: Conditional reconfiguration candidate becomes amount of offset better than PCell/PSCell.
   1> The UE shall consider the entering condition for this event to be satisfied when condition A3-1, as specified below, is satisfied.
   2> The UE shall consider the leaving condition for this event to be satisfied when condition A3-2, as specified below, is satisfied.
      Inequality A3-1 (Entering condition): Mn+Ofn+Ocn Hys>Mp+Ofp+Ocp+Off
      Inequality A3-2 (Leaving condition): Mn+Ofn+Ocn+Hys<Mp+Ofp+Ocp+Off
   The variables in the formula are defined as follows:
      Mn is the measurement result of the neighbour cell, not taking into account any offsets.
      Ofn is the measurement object specific offset of the reference signal of the neighbour cell (i.e., offsetMO as defined within measObjectNR corresponding to the neighbour cell).
      Ocn is the cell specific offset of the neighbour cell (i.e., celllndividualOffset as defined within measObjectNR corresponding to the frequency of the neighbour cell), and set to zero if not configured for the neighbour cell.
      Mp is the measurement result of the SpCell, not taking into account any offsets.
      Ofp is the measurement object specific offset of the SpCell (i.e., offsetMO as defined within measObjectNR corresponding to the SpCell).
      Ocp is the cell specific offset of the SpCell (i.e., celllndividualOffset as defined within measObjectNR corresponding to the SpCell), and is set to zero if not configured for the SpCell.
      Hys is the hysteresis parameter for this event (i.e., hysteresis as defined within reportConfigNR for this event).
      Off is the offset parameter for this event (i.e., a3-Offset as defined within reportConfigNR for this event).
      Mn, Mp are expressed in dBm in case of RSRP, or in dB in case of RSRQ and RS-SINR.
      Ofn, Ocn, Ofp, Ocp, Hys, Off are expressed in dB.
2) CondEvent A4: Conditional reconfiguration candidate becomes better than an absolute threshold.
   1> The UE shall consider the entering condition for this event to be satisfied when condition A4-1, as specified below, is fulfilled.
   2> The UE shall consider the leaving condition for this event to be satisfied when condition A4-2, as specified below, is fulfilled.
      Inequality A4-1 (Entering condition): Mn+Ofn+Ocn Hys>Thresh
      Inequality A4-2 (Leaving condition): Mn+Ofn+Ocn+Hys<Thresh
   The variables in the formula are defined as follows:
      Mn is the measurement result of the neighbour cell, not taking into account any offsets.
      Ofn is the measurement object specific offset of the neighbour cell (i.e., offsetMO as defined within measObjectNR corresponding to the neighbour cell).
      Ocn is the measurement object specific offset of the neighbour cell (i.e., cellIndividualOffset as defined within measObjectNR corresponding to the neighbour cell), and set to zero if not configured for the neighbour cell.
      Hys is the hysteresis parameter for this event (i.e., hysteresis as defined within reportConfigNR for this event).
      Thresh is the threshold parameter for this event (i.e., a4-Threshold as defined within reportConfigNR for this event).
      Mn is expressed in dBm in case of RSRP, or in dB in case of RSRQ and RS-SINR.
      Ofn, Ocn, Hys are expressed in dB.
      Thresh is expressed in the same unit as Mn.
3) CondEvent A5: PCell/PSCell becomes worse than one absolute threshold and Conditional reconfiguration candidate becomes better than another absolute threshold.
   1> The UE shall consider the entering condition for this event to be satisfied when both condition A5-1 and condition A5-2, as specified below, are satisfied.
   1> The UE shall consider the leaving condition for this event to be satisfied when condition A5-3 or condition A5-4, i.e., at least one of the two, as specified below, is satisfied.
      Inequality A5-1 (Entering condition 1): Mp+Hys<Thresh1
      Inequality A5-2 (Entering condition 2): Mn+Ofn+Ocn Hys>Thresh2
      Inequality A5-3 (Leaving condition 1): Mp−Hys>Thresh1
      Inequality A5-4 (Leaving condition 2): Mn+Ofn+Ocn+Hys<Thresh2
   The variables in the formula are defined as follows:
      Mp is the measurement result of the NR SpCell, not taking into account any offsets.
      Mn is the measurement result of the neighbour cell, not taking into account any offsets.
      Ofn is the measurement object specific offset of the neighbour cell (i.e., offsetMO as defined within measObjectNR corresponding to the neighbour cell).
      Ocn is the cell specific offset of the neighbour cell (i.e., cellIndividualOffset as defined within measObjectNR corresponding to the neighbour cell), and set to zero if not configured for the neighbour cell.
      Hys is the hysteresis parameter for this event (i.e., hysteresis as defined within reportConfigNR for this event).
      Thresh1 is the threshold parameter for this event (i.e., a5-Threshold1 as defined within reportConfigNR for this event).
      Thresh2 is the threshold parameter for this event (i.e., a5-Threshold2 as defined within reportConfigNR for this event).
      Mn, Mp are expressed in dBm in case of RSRP, or in dB in case of RSRQ and RS-SINR.
      Ofn, Ocn, Hys are expressed in dB.
      Thresh1 is expressed in the same unit as Mp.
      Thresh2 is expressed in the same unit as Mn.

As in an intra-NR (new radio) RAN (radio access network) handover procedure, in an intra-NR RAN CHO procedure, the preparation and execution phase of the conditional handover procedure is performed without involvement of the 5G core (5GC); i.e., preparation messages are directly exchanged between BSs. The release of resources at the source BS during the conditional handover completion phase is triggered by the target BS.

In 3GPP Rel-15 LTE or EUTRAN system, some aerial UE functions are specified. As specified in 3GPP TS36.331, regarding an RRM enhancement, in a height based measurement report, two reporting events, i.e., Event H1, Event H2, are introduced as below. The height based measurement report specified in 3GPP Rel-15 LTE may also be applied for NR system.
1) Event H1 (Aerial UE height is above a threshold): a height based measurement report would be triggered when Aerial UE's height is above a threshold.
   1> The UE shall consider an entering condition for Event H1 to be satisfied when condition H1-1, as specified below, is satisfied.
   1> The UE shall consider a leaving condition for Event H1 to be satisfied when condition H1-2, as specified below, is satisfied.
      Inequality H1-1 (Entering condition): Ms−Hys>Thresh+Offset
      Inequality H1-2 (Leaving condition): Ms+Hys<Thresh+Offset
   The variables in the above two formulas are defined as follows:
      Ms is the Aerial UE height, not taking into account any offsets.
      Hys is the hysteresis parameter (i.e., h1-Hysteresis as defined within ReportConfigEUTRA) for this event.
      Thresh is the reference threshold parameter for this event given in MeasConfig (i.e., heightThreshRef as defined within MeasConfig).
      Offset is the offset value to heightThreshRef to obtain the absolute threshold for this event (i.e., h1-ThresholdOffset as defined within ReportConfigEUTRA).
      Ms is expressed in meters.
      Thresh is expressed in the same unit as Ms.
2) Event H2 (Aerial UE height is below a threshold): a height based measurement report would be triggered when Aerial UE's height is below a threshold.
   i> The UE shall consider the entering condition for Event H2 to be satisfied when condition H2-1, as specified below, is satisfied.
   i> The UE shall consider the leaving condition for Event H2 to be satisfied when condition H2-2, as specified below, is satisfied.
      Inequality H2-1 (Entering condition): Ms+Hys<Thresh+Offset
      Inequality H2-2 (Leaving condition): Ms−Hys>Thresh+Offset
   The variables in the above two formulas are defined as follows:
      Ms is the Aerial UE height, not taking into account any offsets.
      Hys is the hysteresis parameter (i.e., h2-Hysteresis as defined within ReportConfigEUTRA) for this event.
      Thresh is the reference threshold parameter for this event given in MeasConfig (i.e., heightThreshRef as defined withinMeasConfig).
      Offset is the offset value to heightThreshRef to obtain the absolute threshold for this event. (i.e., h2-ThresholdOffset as defined within ReportConfigEUTRA).
      Ms is expressed in meters.
      Thresh is expressed in the same unit as Ms.

Regarding planned flight path reporting, if a UE (i.e., UAV) has flight path information available, it can inform a network node, for example, an indication, e.g., an information element (IE) flightPathlnfoAvailable can be included in RRCConnectionSetupComplete message, RRCConnectionReesumeComplete message, RRCConnectionReestablishmentComplete message, or RRCConnectionReconfigurationComplete message. Then, the network node can configure the UE to report the planned flight path via UElnformationRequest message, for example, the IE FlightPathlnfoReportConfig can be included in UElnformationRequest message. The UE can send the planned flight path to the requested network via UElnformationRequest message, for example, the IE FightPathlnfoReport can be included in the UElnformationRequest message. The IE LocationInfo can be used to transfer detailed location information available at the UE to correlate measurements and UE position information. The IE AbsoluteTimelnfo can indicate an absolute time in a format YY-MAI-DD HH:MM:SS and using BCD encoding. The first or leftmost bit of the bit string contains the most significant bit of the most significant digit of the year and so on. The planned flight path reporting mechanism specified in 3GPP Rel-15 LTE may also be applied for 3GPP NR.

In general, one of the functions of a MRO mechanism is to detect connection failures that occur due to “Too Early” or “Too Late Handovers”, or “Handover to Wrong Cell”. These problems are defined as follows:
(1) [Intra-system Too Late Handover] An RLF occurs after the UE has stayed for a long period of time in the cell; the UE attempts to re-establish the radio link connection in a different cell.
(2) [Intra-system Too Early Handover] An RLF occurs shortly after a successful handover from a source cell to a target cell or a handover failure occurs during the handover procedure; the UE attempts to re-establish the radio link connection in the source cell.
(3) [Intra-system Handover to Wrong Cell] An RLF occurs shortly after a successful handover from a source cell to a target cell or a handover failure occurs during the handover procedure; the UE attempts to re-establish the radio link connection in a cell other than the source cell and the target cell.

In the definition above, the “successful handover” refers to the UE's state, namely, the successful completion of the radio access (RA) procedure.

After a RLF or a handover failure occurs, UE will perform a re-establishment procedure in a cell. The UE will store some information related with the RLF failure and/or handover information. The UE stores the latest RLF-report, including both LTE and NR RLF-report until the RLF-report is fetched by a network node or for 48 hours after the connection failure is detected. For analysis of connection failures, the UE makes the RLF-report available to the network node.

A successful handover report (SHR) has been introduced to enhance the MRO function in 3GPP 5G NR, to provide a more robust mobility via reporting failure events observed during successful handovers. A UE may compile a SHR which is associated with a successful handover comprising a set of measurements collected during the handover phase, i.e., measurement at the handover trigger, measurement at the end of handover execution, or measurement after handover execution. The UE could be configured with trigger condition(s) to compile the SHR. Hence, the SHR would be triggered only if the trigger condition(s) is met.

The availability of a SHR may be indicated by the Handover Complete message (e.g., RRCConnectionReconfigurationComplete message or RRCReconfigurationComplete message) transmitted from a UE to target node (e.g., EUTRAN node or NG-RAN node) over RRC signalling. The target node (e.g., EUTRAN node or NG-RAN node) may fetch information of a SHR via “UE Information Request mechanism” or “UE Information Response mechanism”. In addition, the target node (e.g., EUTRAN node or NG-RAN node) could then forward the SHR included in ACCESS AND MOBILITY INDICATION message to the source node (e.g., EUTRAN node or NG-RAN node) via Xn or X2 interface, to indicate failure(s) experienced during a successful handover event.

Upon reception of a SHR, the receiving node is able to analyse whether its mobility configuration needs adjustment. Such adjustments may result in changes of mobility configurations, such as, changes of radio link monitoring (RLM) configurations or changes of mobility thresholds between the source node and the target node. In addition, for a target NG-RAN node, in the performed handover, may further optimize the dedicated RACH-beam resources based on the beam measurements reported upon successful handovers.

In 3GPP RAN #93, it is proposed to study mobility enhancements, e.g., a CHO procedure for UAV in 3GPP Rel-18, for example, a new trigger conditions for CHO should be considered. It was proposed that Rel-17 specific CHO mechanism for NTN can be applied for UAV. For CHO in a non-terrestrial network (NTN), since the serving node knows the satellite ephemeris, based on the satellite ephemeris and UE location, a network node can configure suitable CHO execution condition, i.e., “Distance and RRM execution condition” or “Time and RRM execution condition”. However, in UAV, the UE planned flight path is optionally reported, a network node cannot always know how to configure distance or time based CHO execution condition. Thus, “Distance and RRM CHO execution condition” or “Time and RRM CHO execution condition” which is specified for NTN cannot always be applied for UAV mobility.

Currently, an enhanced mobility mechanism for UAV is considered, while following issues need to be addressed:
(1) issue 1: what is an UAV specific CHO execution condition, and how an UAV specific CHO execution condition is configured;
(2) issue 2: a UE how to handle for UAV specific CHO evaluation and execution; and
(3) issue 3: what is a MRO mechanism for mobility in UAV.

Embodiments of the present application aim to solve the above-mentioned issues. Specifically, some embodiments of the present application solve issue 1. In these embodiments, an UAV specific CHO execution condition can be a height based condition (e.g., CondEvent H1, CondEvent H2, or CondEvent H3 as described below) or a flight path based condition (e.g., one or more location coordinates of a UE); the UAV specific CHO execution condition may be configured per a candidate cell by the source network node; and the UAV specific CHO execution condition can be set as a CHO execution condition in combination with CondEvent A3, CondEvent A4, or CondEvent A5.

Some further embodiments of the present application solve issue 2. In these embodiments, when a height based (or flight path based) condition is satisfied, a UE starts to evaluate corresponding RRM based condition; or the order to evaluate a height condition (or a flight path based condition) and an RRM condition is up to the UE's implementation; when both the height (or flight path) based execution condition and the RRM based execution conditions for one candidate cell are satisfied, this candidate cell can be selected as a target cell, and a CHO procedure can be executed, e.g., the UE may access to the target cell; and the target cell selected by the UE can be one candidate cell with execution condition(s) satisfied where the UE is moving towards, or the candidate cell with execution condition(s) satisfied which is nearest to a next destination.

Some other embodiments of the present application solve issue 3. In these embodiments, a RLF-report can include height related information (or location coordinates) when a RLF or a handover execution failure or a CHO execution failure or a CHO recovery failure occurs; and a SHR can include height related information (or location coordinates) when the HO procedure is successful.

More details will be illustrated in the following text in combination with the appended drawings. Persons skilled in the art should well know that the wording “a/the first,” “a/the second” and “a/the third” etc. are only used for clear description, and should not be deemed as any substantial limitation, e.g., sequence limitation.

FIG. 2 illustrates an exemplary block diagram of an apparatus according to some embodiments of the present application. As shown in FIG. 2, the apparatus 200 may include at least one processor 504 and at least one transceiver 202 coupled to the processor 204. The at least one transceiver 202 may be a wired transceiver or a wireless transceiver. The apparatus 200 may be a UE or a network node (e.g., a BS).

Although in this figure, elements such as the at least one transceiver 202 and the processor 204 are described in the singular, the plural is contemplated unless a limitation to the singular is explicitly stated. In some embodiments of the present application, the transceiver 202 may be divided into two devices, such as a receiving circuitry and a transmitting circuitry. In some embodiments of the present application, the apparatus 200 may further include an input device, a memory, and/or other components.

In some embodiments of the present application, the apparatus 200 may be a UE (e.g., UE 101a as shown and illustrated in FIG. 1). The processor 204 of the UE may be configured to receive, via the transceiver 202 of the UE, configuration information of a CHO procedure regarding at least one of a height based condition (e.g., CondEvent H1, CondEvent H2, or CondEvent H3 as described in Embodiments 1-4 as follows) or a flight path based condition (e.g., location coordinate(s) of the UE as described in Embodiments 1-4 as follows). The configuration information of the CHO procedure may contain configuration of CHO candidate cell(s) generated by candidate node(s) (e.g., BS 102b or BS 102c as shown and illustrated in FIG. 1), and execution condition(s) generated by a source network node (e.g., BS 102a as shown and illustrated in FIG. 1) or the candidate network node(s).

The processor 204 of the UE may be further configured to evaluate whether at least one execution condition for at least one candidate cell of the CHO procedure is satisfied, wherein the at least one execution condition includes the at least one of the height based condition or the flight path based condition; and to execute the CHO procedure upon the at least one execution condition being satisfied.

In some embodiments, the height based condition or the flight path based condition is configured per a candidate cell. In some embodiments, the at least one execution condition for a candidate cell of the CHO procedure includes one or more trigger conditions, and the one or more trigger conditions are the height based condition or the flight path based condition. In some embodiments, two or more execution conditions for a candidate cell of the CHO procedure are configured simultaneously to the candidate cell.

According to some embodiments, the processor 204 of the UE may be configured to receive, via the transceiver 202 of the UE, configuration information of the CHO procedure regarding a RRM based condition (e.g., CondEvent A3, CondEvent A4, or CondEvent A5 as described in Embodiments 1-4 as follows). In some embodiments, the at least one execution condition for the at least one candidate cell of the CHO procedure further includes the RRM based condition, and the CHO procedure is executed upon both the RRM based condition and the at least one of the height based condition or the flight path based condition for the at least one candidate cell of the CHO procedure being satisfied.

In some embodiments, during evaluating whether the at least one execution condition for the at least one candidate cell of the CHO procedure is satisfied, the processor 204 of the UE is configured:
(1) to evaluate the RRM based condition (e.g., CondEvent A3, CondEvent A4, or CondEvent A5), upon the height based condition (e.g., CondEvent H1, CondEvent H2, or CondEvent H3) or the flight path based condition (e.g., one or more location coordinates of the UE) being satisfied;
(2) to simultaneously evaluate the RRM based condition and the height based condition;
(3) to evaluate the height based condition, upon the RRM based condition or the flight path based condition being satisfied;
(4) to simultaneously evaluate the RRM based condition and the flight path based condition; or
(5) to evaluate the flight path based condition, upon the RRM based condition or the height based condition being satisfied.

In some embodiments, upon the at least one execution condition for multiple candidate cells being satisfied, the processor 204 of the UE is configured to select one cell within the multiple candidate cells as a target cell of the CHO procedure to execute the CHO procedure. The target cell may be a candidate cell towards which the UE is moving, or a candidate cell which is nearest to a next destination of the UE, or a candidate cell whose quality is getting better during evaluating a timer to trigger (TTT). TTT is for evaluating whether the at least one execution condition for the at least one candidate cell of the CHO procedure is satisfied.

According to some embodiments, the processor 204 of the UE may be configured: to store height related assistance information; and to transmit the height related assistance information via the transceiver 202 of the UE. For example, the height related assistance information may be stored in response to failing to complete the CHO procedure. In some embodiments, the height related assistance information includes at least one of:
(1) information or an indication which indicates whether the height based condition is satisfied when a failure occurs, wherein the failure includes at least one of: a source RLF, a handover failure, or a CHO execution failure;
(2) information or an indication which indicates whether the flight path based condition is satisfied when the failure occurs;
(3) height information of the UE when the failure occurs;
(4) a location coordinate of the UE when the failure occurs;
(5) the height information of the UE when a CHO recovery procedure is successful;
(6) the height information of the UE when the CHO recovery procedure is failed;
(7) the location coordinate of the UE when the CHO recovery procedure is successful;
(8) the location coordinate of the UE when the CHO recovery procedure is failed;
(9) information or an indication which indicates whether a selected candidate cell for the CHO recovery procedure satisfies the height based condition; or
(10) information or an indication which indicates whether the selected candidate cell for the CHO recovery procedure satisfies the flight path based condition.

According to some embodiments, the processor 204 of the UE may be configured to receive, via the transceiver 202 of the UE, configuration information regarding a triggering condition for logging or generating or storing a successful handover report (SHR). For example, the triggering condition for logging or generating or storing the SHR includes at least one of:
(1) height information of the UE is higher than a threshold;
(2) the height information of the UE is lower than a further threshold; or
(3) a location coordinate of the UE is located within a location coordinate range.

In the embodiments of the present application, the location coordinate range may be represented by multiple manners. For example, the location coordinate range may include multiple location coordinates, may include multiple longitude information and/or latitude information and/or height information, or may include grid information.

According to some embodiments, the processor 204 of the UE may be configured to generate the SHR, in response to the triggering condition for logging the SHR being satisfied; and to transmit the SHR via the transceiver 202 of the UE (e.g., to a network node that manages a target cell of the UE). For example, the SHR may be generated in response to successfully completing the CHO procedure and in response to the triggering condition for logging the SHR being satisfied. In some embodiments, the SHR includes at least one of.
(1) height information of the UE when the CHO procedure is executed;
(2) the height information of the UE when the CHO procedure is successful; or
(3) information or an indication that indicates which triggering condition for logging the SHR is satisfied, e.g., a cause value for the SHR.

In some embodiments of the present application, the apparatus 200 may be a source network node (e.g., BS 102a as shown and illustrated in FIG. 1). The processor 204 of the source network node may be configured to generate configuration information regarding at least one execution condition for at least one candidate cell of a CHO procedure of a UE (e.g., UE 101a as shown and illustrated in FIG. 1). The at least one execution condition includes at least one of a height based condition or a flight path based condition. The processor 204 of the source network node may be further configured to transmit the configuration information via the transceiver 202 of the source network node to the UE.

According to some embodiments, the processor 204 of the source network node may be configured to perform at least one of following operations. Specific examples are described in Embodiments 1-4 as follows.
(1) Receiving a height based neighbour cell list of a network node (e.g., BS 102b or BS 102c as shown and illustrated in FIG. 1, which may be a candidate node of the CHO procedure) from the network node. The height based neighbour cell list may be received during a Xn setup procedure or an RAN node configuration update procedure.
(2) Transmitting a further height based neighbour cell list of the source network node to the network node. The further height based neighbour cell list may be transmitted during the Xn setup procedure or the RAN node configuration update procedure.
(3) Transmitting an indication to the network node. The indication indicates or instructs the network node to generate the at least one of the height based condition or the flight path based condition. The indication may be carried in a handover (HO) request message.
(4) Receiving, from the network node, information regarding the at least one execution condition for the at least one candidate cell of the CHO procedure of the UE. This information may be carried in a HO request acknowledge message.

According to some embodiments, the processor 204 of the source network node may be configured to receive height related assistance information from the UE or “a further network node managing a target cell of the CHO procedure” or “another third network node where a RRC re-establishment procedure is performed for the CHO procedure”. In some embodiments, the height related assistance information includes at least one of:
(1) information or an indication which indicates whether the height based condition is satisfied when a failure occurs, wherein the failure includes at least one of a source RLF or a handover failure or a CHO execution failure;
(2) information or an indication which indicates whether the flight path based condition is satisfied when the failure occurs;
(3) height information of the UE when the failure occurs;
(4) a location coordinate of the UE when the failure occurs;
(5) the height information of the UE when a CHO recovery procedure is successful;
(6) the height information of the UE when the CHO recovery procedure is failed;
(7) the location coordinate of the UE when the CHO recovery procedure is successful;
(8) the location coordinate of the UE when the CHO recovery procedure is failed;
(9) information or an indication which indicates whether a selected candidate cell for the CHO recovery procedure satisfies the height based condition; or
(10) information or an indication which indicates whether the selected candidate cell for the CHO recovery procedure satisfies the flight path based condition.

According to some embodiments, the processor 204 of the source network node is configured to transmit configuration information regarding a triggering condition for logging or generating a SHR. For example, the triggering condition for logging or generating or storing the SHR includes at least one of:
(1) height information of the UE is higher than a threshold;
(2) the height information of the UE is lower than a further threshold; or
(3) a location coordinate of the UE is located within a location coordinate range.

According to some embodiments, the processor 204 of the source network node may be configured to receive a SHR from a network node managing a target cell of the CHO procedure (e.g., BS 102b or BS 102c as shown and illustrated in FIG. 1). For example, the SHR may be generated in response to successfully completing the CHO procedure and in response to the triggering condition for logging the SHR being satisfied. In some embodiments, the SHR includes at least one of:
(1) height information of the UE when the CHO procedure is executed;
(2) the height information of the UE when the CHO procedure is successful; or
(3) information or an indication that indicates which triggering condition for logging the SHR is satisfied, e.g., a cause value for the SHR.

In some embodiments of the present application, the apparatus 200 may be a network node, for example, a candidate BS or a target BS (e.g., BS 102b or BS 102c as shown and illustrated in FIG. 1). The processor 204 of the network node may be configured: to transmit a height based neighbour cell list of the network node via the transceiver 202 of the network node to a source network node (e.g., BS 102a as shown and illustrated in FIG. 1) of a UE (e.g., UE 101a as shown and illustrated in FIG. 1) and to receive a second height based neighbour cell list of the source network node via the transceiver 202 of the network node from the source network node. Alternatively, the processor 204 of the network node may be configured to receive an indication via the transceiver 202 of the network node from the source network node. The indication indicates the network node to generate information (which is marked as “the 1st information” for simplicity) regarding at least one execution condition for at least one candidate cell of a CHO procedure of the UE. The at least one execution condition includes at least one of a height based condition or a flight path based condition. The indication may be carried in a HO request message.

According to some embodiments, after receiving the indication, the processor 204 of the network node is configured: to generate the 1st information; and to transmit the 1st information via the transceiver 202 of the network node to the source network node. The 1st information may be carried in a HO request acknowledge message.

In some embodiments, the processor 204 of the network node may be further configured: to receive height related assistance information from a third network node where a RRC re-establishment procedure is performed for the CHO procedure or from the UE; and to transmit the height related assistance information to the source network node. For instance, the height related assistance information includes at least one of:
(1) information or an indication which indicates whether the height based condition is satisfied when a failure occurs, wherein the failure includes at least one of: a source RLF, a handover failure, or a CHO execution failure;
(2) information or an indication which indicates whether the flight path based condition is satisfied when the failure occurs;
(3) height information of the UE when the failure occurs;
(4) a location coordinate of the UE when the failure occurs;
(5) the height information of the UE when a CHO recovery procedure is successful;
(6) the height information of the UE when the CHO recovery procedure is failed;
(7) the location coordinate of the UE when the CHO recovery procedure is successful;
(8) the location coordinate of the UE when the CHO recovery procedure is failed;
(9) information or an indication which indicates whether a selected candidate cell for the CHO recovery procedure satisfies the height based condition; or
(10) information or an indication which indicates whether the selected candidate cell for the CHO recovery procedure satisfies the flight path based condition.

According to some embodiments, the processor 204 of the network node is configured to transmit configuration information regarding a triggering condition for logging or generating a SHR. For example, the triggering condition for logging or generating or storing the SHR includes at least one of:
(1) height information of the UE is higher than a threshold;
(2) the height information of the UE is lower than a further threshold; or
(3) a location coordinate of the UE is located within a location coordinate range.

According to some embodiments, the processor 204 of the network node may be configured to receive a SHR from the UE and to transmit the SHR to the source network node. In some embodiments, the SHR includes at least one of:
(1) height information of the UE when the CHO procedure is executed;
(2) the height information of the UE when the CHO procedure is successful; or
(3) information or an indication that indicates which triggering condition for logging the SHR is satisfied, e.g., a cause value for the SHR.

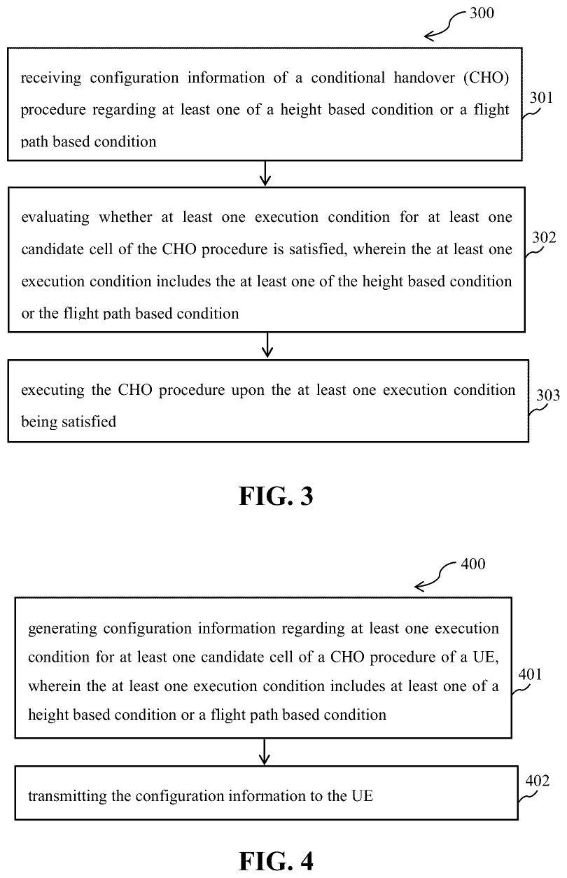

In some embodiments of the present application, the apparatus 200 may include at least one non-transitory computer-readable medium. In some embodiments of the present disclosure, the non-transitory computer-readable medium may have stored thereon computer-executable instructions to cause a processor to implement the method with respect to a UE or a network node (e.g., a BS) as described above. For example, the computer-executable instructions, when executed, cause the processor 204 interacting with the transceiver 202, so as to perform operations of the methods, e.g., as described in view of FIGS. 3 and 4.

FIG. 3 illustrates a flowchart of executing a CHO procedure according to some embodiments of the present application. The method 300 may be performed by a UE (e.g., UE 101a as shown and illustrated in FIG. 1). Although described with respect to a UE, it should be understood that other devices may also be configured to perform the method as shown and illustrated in FIG. 3.

In the exemplary method 300 as shown in FIG. 3, in operation 301, a UE (e.g., UE 101 as shown and illustrated in FIG. 1) receives configuration information of a CHO procedure regarding at least one of “a height based condition” (e.g., CondEvent H1, CondEvent H2, or CondEvent H3 as described in Embodiments 1-4 as follows) or” a flight path based condition” (e.g., one or more location coordinates of the UE as described in Embodiments 1-4 as follows). In some embodiments, the height based condition or the flight path based condition is configured per a candidate cell.

In operation 302 as shown in FIG. 3, the UE evaluates whether at least one execution condition for at least one candidate cell of the CHO procedure is satisfied. The at least one execution condition includes at least one of the height based condition or the flight path based condition. In some embodiments, the at least one execution condition for a candidate cell of the CHO procedure includes one or more trigger conditions, wherein the one or more trigger conditions are the height based condition or the flight path based condition. In some embodiments, two or more execution conditions for a candidate cell of the CHO procedure are configured simultaneously to the candidate cell.

In operation 303 as shown in FIG. 3, the UE executes the CHO procedure upon the at least one execution condition being satisfied. It is contemplated that the method illustrated in FIG. 3 may include other operation(s) not shown, for example, any operation(s) described with respect to FIGS. 2, 4, and 5.

According to some embodiments, the UE receives (e.g., from a source network node) configuration information of the CHO procedure regarding a RRM based condition. In some embodiments, the at least one execution condition for the at least one candidate cell of the CHO procedure further includes the RRM based condition. The CHO procedure is executed upon both “the RRM based condition” and “the at least one of the height based condition or the flight path based condition” for the at least one candidate cell of the CHO procedure being satisfied.

In some embodiments, during evaluating whether the at least one execution condition for the at least one candidate cell of the CHO procedure is satisfied, the UE is configured:
(1) to evaluate the RRM based condition (e.g., CondEvent A3, CondEvent A4, or CondEvent A5), upon the height based condition (e.g., CondEvent H1, CondEvent H2, or CondEvent H3) or the flight path based condition (e.g., one or more location coordinates of the UE) being satisfied;
(2) to simultaneously evaluate the RRM based condition and the height based condition;
(3) to evaluate the height based condition, upon the RRM based condition or the flight path based condition being satisfied;
(4) to simultaneously evaluate the RRM based condition and the flight path based condition; or
(5) to evaluate the flight path based condition, upon the RRM based condition or the height based condition being satisfied.

In some embodiments, upon the at least one execution condition for multiple candidate cells being satisfied, the UE selects one cell within the multiple candidate cells as a target cell of the CHO procedure to execute the CHO procedure. The target cell may be a candidate cell towards which the UE is moving, or a candidate cell which is nearest to a next destination of the UE, or a candidate cell whose quality is getting better during evaluating a timer to trigger (TTT) which is for evaluating whether the at least one execution condition for the at least one candidate cell of the CHO procedure is satisfied.

According to some embodiments, the UE may be configured: to store height related assistance information; and to transmit the height related assistance information. For example, the height related assistance information may be stored in response to failing to complete the CHO procedure. In some embodiments, the height related assistance information includes at least one of:
(1) information or an indication which indicates whether the height based condition is satisfied when a failure occurs, wherein the failure includes at least one of: a source RLF, a handover failure, or a CHO execution failure;
(2) information or an indication which indicates whether the flight path based condition is satisfied when the failure occurs;
(3) height information of the UE when the failure occurs;
(4) a location coordinate of the UE when the failure occurs;
(5) the height information of the UE when a CHO recovery procedure is successful;
(6) the height information of the UE when the CHO recovery procedure is failed;
(7) the location coordinate of the UE when the CHO recovery procedure is successful;
(8) the location coordinate of the UE when the CHO recovery procedure is failed;
(9) information or an indication which indicates whether a selected candidate cell for the CHO recovery procedure satisfies the height based condition; or
(10) information or an indication which indicates whether the selected candidate cell for the CHO recovery procedure satisfies the flight path based condition.

According to some embodiments, the UE receives configuration information regarding a triggering condition for logging or generating or storing a SHR. For example, the triggering condition for logging or generating or storing the SHR includes at least one of:
(1) height information of the UE is higher than a threshold;
(2) the height information of the UE is lower than a further threshold; or
(3) a location coordinate of the UE is located within a location coordinate range.

According to some embodiments, the UE generates the SHR, in response to the triggering condition for logging the SHR being satisfied; and to transmit the SHR (e.g., to a network node that manages a target cell of the UE). For example, the SHR may be generated in response to successfully completing the CHO procedure and in response to the triggering condition for logging the SHR being satisfied. In some embodiments, the SHR includes at least one of.
(1) height information of the UE when the CHO procedure is executed;
(2) the height information of the UE when the CHO procedure is successful; or
(3) information or an indication that indicates which triggering condition for logging the SHR is satisfied, e.g., a cause value for the SHR.

Details described in all other embodiments of the present application (for example, details regarding mobility enhancements for an UAV) are applicable for the embodiments of FIG. 3. Moreover, details described in the embodiments of FIG. 3 are applicable for all embodiments of FIGS. 1, 2, 4, and 5. It should be appreciated by persons skilled in the art that the sequence of the operations in exemplary procedure in the embodiments of FIG. 3 may be changed and some of the operations in exemplary procedure in the embodiments of FIG. 3 may be eliminated or modified, without departing from the spirit and scope of the disclosure.

FIG. 4 illustrates a flow chart of transmitting configuration information according to some embodiments of the present application. The embodiments of FIG. 4 may be performed by a source network node (e.g., BS 102a as shown and illustrated in FIG. 1). Although described with respect to a source network node, it should be understood that other devices may be configured to perform a method similar to that of FIG. 4.

In the exemplary method 400 as shown in FIG. 4, in operation 401, a source network node (e.g., BS 102a as shown and illustrated in FIG. 1) generates configuration information regarding at least one execution condition for at least one candidate cell of a CHO procedure of a UE (e.g., UE 101a as shown and illustrated in FIG. 1). The at least one execution condition includes at least one of “a height based condition” (e.g., CondEvent H1, CondEvent H2, or CondEvent H3 as described in Embodiments 1-4 as follows) or“a flight path based condition” (e.g., one or more location coordinates of the UE as described in Embodiments 1-4 as follows). In operation 402 as shown in FIG. 4, the source network node transmits the configuration information to the UE.

It is contemplated that the method illustrated in FIG. 4 may include other operation(s) not shown, for example, any operation(s) described with respect to FIGS. 2, 3, and 5.

According to some embodiments, the source network node performs at least one of following operations.
(1) Receiving a height based neighbour cell list of a network node (e.g., BS 102b or BS 102c as shown and illustrated in FIG. 1, which is a candidate node of the CHO procedure) from the network node. The height based neighbour cell list may be received during a Xn setup procedure or an RAN node configuration update procedure.
(2) Transmitting a further height based neighbour cell list of the source network node to the network node. The further height based neighbour cell list may be transmitted during the Xn setup procedure or the RAN node configuration update procedure.
(3) Transmitting an indication to the network node. The indication indicates or instructs the network node to generate the at least one of the height based condition or the flight path based condition. The indication may be carried in a handover (HO) request message.
(4) Receiving, from the network node, information regarding the at least one execution condition for the at least one candidate cell of the CHO procedure of the UE. This information may be carried in a HO request acknowledge message.

According to some embodiments, the source network node receives height related assistance information from the UE or from “a further network node managing a target cell of the CHO procedure” from or “another network node where a RRC re-establishment procedure is performed for the CHO procedure”. In some embodiments, the height related assistance information includes at least one of:
(1) information or an indication which indicates whether the height based condition is satisfied when a failure occurs, wherein the failure includes at least one of a source RLF or a handover failure or a CHO execution failure;
(2) information or an indication which indicates whether the flight path based condition is satisfied when the failure occurs;
(3) height information of the UE when the failure occurs;
(4) a location coordinate of the UE when the failure occurs;
(5) the height information of the UE when a CHO recovery procedure is successful;
(6) the height information of the UE when the CHO recovery procedure is failed;
(7) the location coordinate of the UE when the CHO recovery procedure is successful;
(8) the location coordinate of the UE when the CHO recovery procedure is failed;
(9) information or an indication which indicates whether a selected candidate cell for the CHO recovery procedure satisfies the height based condition; or
(10) information or an indication which indicates whether the selected candidate cell for the CHO recovery procedure satisfies the flight path based condition.

According to some embodiments, the source network node transmits configuration information regarding a triggering condition for logging or generating or storing a SHR. For example, the triggering condition for logging or generating or storing the SHR includes at least one of:
(1) height information of the UE is higher than a threshold;
(2) the height information of the UE is lower than a further threshold; or
(3) a location coordinate of the UE is located within a location coordinate range.

According to some embodiments, the source network node receives a SHR from a network node managing a target cell of the CHO procedure (e.g., BS 102b or BS 102c as shown and illustrated in FIG. 1, which can be regarded as the target network node). For example, the SHR may be generated in response to successfully completing the CHO procedure and in response to the triggering condition for logging the SHR being satisfied. In some embodiments, the SHR includes at least one of:
(1) height information of the UE when the CHO procedure is executed;
(2) the height information of the UE when the CHO procedure is successful; or
(3) information or an indication that indicates which triggering condition for logging the SHR is satisfied, e.g., a cause value for the SHR.

Details described in all other embodiments of the present application (for example, details regarding mobility enhancements for an UAV) are applicable for the embodiments of FIG. 4. Moreover, details described in the embodiments of FIG. 4 are applicable for all embodiments of FIGS. 1, 2, 3, and 5. It should be appreciated by persons skilled in the art that the sequence of the operations in exemplary procedure in the embodiments of FIG. 4 may be changed and some of the operations in exemplary procedure in the embodiments of FIG. 4 may be eliminated or modified, without departing from the spirit and scope of the disclosure.

Some embodiments of the present application disclose a method of generating information regarding execution condition(s) for candidate cell(s) of a CHO procedure of a UE. These embodiments may be performed by a network node, e.g., a candidate network node or a target network node (e.g., BS 102b or BS 102c as shown and illustrated in FIG. 1). Although described with respect to a network node, it should be understood that other devices may be configured to perform the abovementioned method. Details described in all other embodiments of the present application (for example, details regarding mobility enhancements for an UAV) are applicable for these embodiments. Moreover, details described in these embodiments are applicable for all embodiments of FIGS. 1-4.

In particular, in some embodiments of the abovementioned method, a network node (e.g., BS 102b as shown and illustrated in FIG. 1, which is a neighbor network node of a source network node) transmits a height based neighbour cell list of the network node to a source network node (e.g., BS 102a as shown and illustrated in FIG. 1) of a UE (e.g., UE 101a as shown and illustrated in FIG. 1), and receives a further height based neighbour cell list of the source network node from the source network node. In other words, the network node exchanges height based neighbour cell lists with the source network node.

In some other embodiments of the abovementioned method, the network node (e.g., BS 102b as shown and illustrated in FIG. 1, which is a candidate network node of the CHO procedure) receives an indication from the source network node. The indication indicates the network node to generate information regarding at least one execution condition for at least one candidate cell of a CHO procedure of the UE. The at least one execution condition includes at least one of “a height based condition” (e.g., CondEvent H1, CondEvent H2, or CondEvent H3 as described in Embodiments 1-4 as follows) or“a flight path based condition” (e.g., one or more location coordinates of the UE as described in Embodiments 1-4 as follows). The indication may be carried in a HO request message.

According to some embodiments of the abovementioned method, after receiving the indication, the network node generates the information regarding the at least one execution condition; and to transmit the information regarding the at least one execution condition to the source network node. The information regarding the at least one execution condition may be carried in a HO request acknowledge message.

In some embodiments of the abovementioned method, the network node receives height related assistance information from another network node (e.g., BS 102c as shown and illustrated in FIG. 1) where a RRC re-establishment procedure is performed for the CHO procedure or from the UE; and transmits the height related assistance information to the source network node. For instance, the height related assistance information includes at least one of:
(1) information or an indication which indicates whether the height based condition is satisfied when a failure occurs, wherein the failure includes at least one of: a source RLF, a handover failure, or a CHO execution failure;
(2) information or an indication which indicates whether the flight path based condition is satisfied when the failure occurs;
(3) height information of the UE when the failure occurs;
(4) a location coordinate of the UE when the failure occurs;
(5) the height information of the UE when a CHO recovery procedure is successful;
(6) the height information of the UE when the CHO recovery procedure is failed;
(7) the location coordinate of the UE when the CHO recovery procedure is successful;
(8) the location coordinate of the UE when the CHO recovery procedure is failed;
(9) information or an indication which indicates whether a selected candidate cell for the CHO recovery procedure satisfies the height based condition; or
(10) information or an indication which indicates whether the selected candidate cell for the CHO recovery procedure satisfies the flight path based condition.

According to some embodiments of the abovementioned method, the network node transmits configuration information regarding a triggering condition for logging or generating or storing a SHR. For example, the triggering condition for logging or generating or storing the SHR includes at least one of:
(1) height information of the UE is higher than a threshold;
(2) the height information of the UE is lower than a further threshold; or
(3) a location coordinate of the UE is located within a location coordinate range.

According to some embodiments of the abovementioned method, the network node receives a SHR from the UE and transmits the SHR to the source network node. In some embodiments, the SHR includes at least one of:
(1) height information of the UE when the CHO procedure is executed;
(2) the height information of the UE when the CHO procedure is successful; or
(3) information or an indication that indicates which triggering condition for logging the SHR is satisfied, e.g., a cause value for the SHR.

The following texts describe specific Embodiments 1-4 of the methods as shown and illustrated in FIGS. 3 and 4. According to Embodiments 1-4, a UE (e.g., UE 101a as shown and illustrated in FIG. 1) and a network node (e.g., BS 102a, BS 102b, or BS 102c as shown and illustrated in FIG. 1) perform following operations.

### Embodiment 1

Embodiment 1 refers to UAV specific CHO configuration. In Embodiment 1, when configuring a CHO procedure, since a cell deployment is different at different heights which may cause UAV “sees” different neighbour cells at different heights, CHO configurations (e.g., CHO execution conditions or the candidate cell list) need to be differentiated by different heights. For example, when the UE's height is lower than height 1, cell 1, cell 2, or cell 3 can be configured as candidate cells. When the UE's height is higher than height 2, cell 3, cell 4, or cell 5 can be configured as the candidate cells. When the UE's height is higher than height 1 and lower than height2, cell 1, cell 2, or cell 6 can be configured as the candidate cells.

In Embodiment 1, a height based event or condition (e.g., CondEvent H1, CondEvent H2, or CondEvent H3) is introduced as a CHO execution condition. The condition of CondEvent H1 can be defined as satisfied when “the height where an Aerial UE can access or handover to a conditional reconfiguration candidate” is above a threshold. The condition of CondEvent H2 can be defined as satisfied when “the height where an Aerial UE can access or handover to a conditional reconfiguration candidate” is below a threshold. The condition of CondEvent H3 can be defined as satisfied when “the height where an Aerial UE can access to or handover to a conditional reconfiguration candidate” is above a threshold and below another threshold.

In Embodiment 1, CondEvent H1, CondEvent H2, and CondEvent H3 may be defined as follows.
1) CondEvent H1 (Aerial UE height is above a threshold): for example, access or handover to a candidate cell of CHO procedure would be triggered when Aerial UE's height is above a threshold.
   1> The UE shall consider an entering condition for CondEvent H1 to be satisfied when condition H1-1, as specified below, is satisfied.
   1> The UE shall consider a leaving condition for CondEvent H1 to be satisfied when condition H1-2, as specified below, is satisfied.
      Inequality H1-1 (Entering condition): Ms−Hys>Thresh+Offset
      Inequality H1-2 (Leaving condition): Ms+Hys<Thresh+Offset
   The variables in the above two formulas are defined as follows:
      Ms is the Aerial UE height, not taking into account any offsets.
      Hys is the hysteresis parameter (e.g., in LTE or EUTRAN system, h1-Hysteresis as defined within ReportConfigEUTRA) for this event.
      Thresh is the reference threshold parameter for this event given in MeasConfig (e.g., in LTE or EUTRAN system, heightThreshRef as defined within MeasConfig).
      Offset is the offset value to heightThreshRef to obtain the absolute threshold for this event (e.g., in LTE or EUTRAN system, h1-ThresholdOffset as defined within ReportConfigEUTRA).
      Ms is expressed in meters.
      Thresh is expressed in the same unit as Ms.
2) CondEvent H2 (Aerial UE height is below a threshold): for example, access or handover to a candidate cell of CHO procedure would be triggered when Aerial UE's height is below a threshold.
   1> The UE shall consider the entering condition for CondEvent H2 to be satisfied when condition H2-1, as specified below, is satisfied.
   1> The UE shall consider the leaving condition for CondEvent H2 to be satisfied when condition H2-2, as specified below, is satisfied.
      Inequality H2-1 (Entering condition): Ms+Hys<Thresh+Offset
      Inequality H2-2 (Leaving condition): Ms−Hys>Thresh+Offset
   The variables in the above two formulas are defined as follows:
      Ms is the Aerial UE height, not taking into account any offsets.
      Hys is the hysteresis parameter (e.g., in LTE or EUTRAN system, h2-Hysteresis as defined within ReportConfigEUTRA) for this event.
      Thresh is the reference threshold parameter for this event given in MeasConfig (e.g., in LTE or EUTRAN system, heightThreshRef as defined within MeasConfig).
      Offset is the offset value to heightThreshRef to obtain the absolute threshold for this event. (e.g., in LTE or EUTRAN system, h2-ThresholdOffset as defined within ReportConfigEUTRA).
      Ms is expressed in meters.
      Thresh is expressed in the same unit as Ms.
3) CondEvent H3 (Aerial UE height is above a threshold and below a further threshold). For example, access or handover to a candidate cell of CHO procedure would be triggered when Aerial UE's height is above a threshold and below a further threshold.
   1> The UE shall consider the entering condition for CondEvent H3 to be satisfied when both condition H3-1 and condition H3-2, as specified below, are fulfilled.
   1> The UE shall consider the leaving condition for CondEvent H3 to be satisfied when condition H3-3 or condition H3-4, i.e., at least one of the two, as specified below, is fulfilled.
      Inequality H3-1 (Entering condition 1): Ms−Hys>Thresh1+Offset1
      Inequality H3-2 (Leaving condition 1): Ms+Hys<Thresh1+Offset1
      Inequality H3-2 (Entering condition 2): Ms+Hys<Thresh2+Offset2
      Inequality H3-4 (Leaving condition 2): Ms−Hys>Thresh2+Offset2
   The variables in the formula are defined as follows:
      Ms is the Aerial UE height, not taking into account any offsets.
      Hys is the hysteresis parameter for this event.
      Thresh1/2 is the reference threshold parameter for this event given in MeasConfig (e.g., in LTE or EUTRAN system, heightThreshRef as defined within MeasConfig).
      Offset1/2 is the offset value to heightThreshRef to obtain the absolute threshold for this event.
      Ms is expressed in meters.
      Thresh1/2 is expressed in the same unit as Ms.

In Embodiment 1, when a height based event or condition (e.g., CondEvent H1, CondEvent H2, or CondEvent H3) is satisfied, the UE may select the candidate cell whose height based event or condition is satisfied as the target cell to execute the CHO procedure, e.g., the UE starts synchronization with the target cell, or, the UE performs a RACH procedure towards the target cell. For example, for candidate cell 1 which is configured with CondEvent H1 as the height based condition, when the height of the UE is above a threshold configured for CondEvent H1, the UE can execute the CHO procedure, e.g., the UE may access or handover to candidate cell 1.

For example, abstract syntax notation one (ASN.1) coding for CondEvent H1 can be as follows.

| | |
|---|---|
| CondEventH1 | SEQUENCE { |
| h1-ThresholdOffset | INTEGER (0..300), |
| h1-Hysteresis | INTEGER (1..16), |
| tisatisfiedoTrigger | TisatisfiedoTrigger |

}
1> The UE shall consider the entering condition for CondEvent H1 to be
satisfied when condition H1-1, e.g., Ms − Hys > Thresh + Offset ,
is satisfied.
1> The UE shall consider the leaving condition for CondEvent H1 to be
satisfied when condition H1-2, e.g., Ms + Hys < Thresh + Offset ,
is satisfied.

For example, ASN.1 coding for and CondEvent H2 can be as follows.

| | |
|---|---|
| CondEventH2 | SEQUENCE { |
| h2-ThresholdOffset | INTEGER (0..300), |
| h2-Hysteresis | INTEGER (1..16), |
| tisatisfiedoTrigger | TisatisfiedoTrigger |

}
1> The UE shall consider the entering condition for CondEvent H2 to be
satisfied when condition H2-1, e.g., Ms + Hys < Thresh + Offset ,
is satisfied.
1> The UE shall consider the leaving condition for CondEvent H2 to be
satisfied when condition H2-2, e.g., Ms − Hys > Thresh + Offset ,
is satisfied.

In Embodiment 1, a height based condition or a height based event (e.g., CondEvent H1, CondEvent H2, or CondEvent H3) may be configured per a candidate cell. That is, the height based condition and a candidate cell may be one-to-multiple mapped or one-to-one mapped. For each candidate cell, the height based condition can be the same or different. For example:
Case 1: For candidate cell 1, CondEvent H1 is configured; and for candidate cell2, CondEvent H2 is configured.
Case 2: For candidate cell 1 and candidate cell 3, CondEvent H1 is configured, and, the parameters of entering condition and/or leaving condition for candidate cell 1 may be different or similar with these for candidate cell 2. If height based conditions for different cells are totally similar, relationships between height based conditions and cells can be one-to-one mapping or one-to-multiple mapping.

In Embodiment 1, a candidate cell can be configured with at least one execution condition, and one execution condition includes one or more trigger conditions. The one or more trigger conditions can be a height based condition or a height based event (e.g., CondEvent H1, CondEvent H2, or CondEvent H3). For example, for candidate cell 1, two execution conditions (e.g., CondEvent H1 and CondEvent H2) are configured simultaneously, and in this case when the height of the UE is above a threshold configured for CondEvent H1 and below another threshold configured for CondEvent H2, the UE can execute the CHO procedure. For candidate cell 2, CondEvent H3 is configured, and in this case when the height of the UE is above a threshold configured for this CondEvent H3 and below another threshold configured for this CondEvent H3, the UE can execute the CHO procedure.

In Embodiment 1, in one way, a height based condition or event (e.g., CondEvent H1, CondEvent H2, or CondEvent H3) may be configured by a source node of the UE.
The source node and a neighbor node can exchange height based neighbour cell lists before performing a CHO procedure, e.g., during XN SETUP/NG-RAN NODE CONFIGURATION UPDATE procedure.
Based on the height based neighbour cell list and “height information, location information, or speed information” received from the UE (e.g., which may be included in the measurement report or a location report), the source node can generate the height based condition (e.g., CondEvent H1, CondEvent H2, or CondEvent H3) which is a part of CHO configurations. The source node can send the CHO configurations to the UE via a RRC message.

In Embodiment 1, in another way, a height based condition or event (e.g., CondEvent H1, CondEvent H2, or CondEvent H3) may be configured by a candidate node.
Step 1: An indication (e.g., “CHO for UAV”) can be included in a HO Request message, to indicate the candidate node to determine height based condition(s). The indication can be an explicit indication, or an implicit indication (e.g., height information, location information, or speed information). Optionally, the allowed flight height range can be included in a HO Request message, which is useful for the candidate target node to determine the candidate cell(s) or height based condition(s).
Step 2: Based on the HO Request message, the candidate node can generate configurations of at least one candidate cell, and decide a height based condition for each candidate cell. The height based condition which is a part of CHO configurations can be included in a HO Request ACK message (outside the RRC container for configurations of candidate cell).
Step 3: The source node sends CHO configurations to the UE via RRC message(s).

In Embodiment 1, a height based event or condition can be set as a CHO execution condition in combination with a RRM based condition, i.e., a CHO execution condition for a candidate cell can include both a height based condition and a RRM based condition. For one cell during one CHO procedure, it can be configured as the CHO candidate cell with “different height based conditions” and/or “different RRM based conditions” independently. For example, for one candidate cell, one or two height based conditions can be configured to the UE simultaneously. Accordingly, different RRM based conditions can be configured which are associated with different height based conditions.

In Embodiment 1, taking candidate cell A as an example, when it is configured with CondEvent H1 and CondEvent H2 by the network node, the network node can configure different RRM based conditions for candidate cell A. That is, a RRM based condition for candidate cell A when it is configured with CondEvent H1 may be different from the RRM based condition for candidate cell A when it is configured with CondEvent H2. For example, candidate cell A can be configured with “CondEvent H1 and CondEvent A3” and “CondEvent H2 and CondEvent A5”, simultaneously during one CHO procedure.

### Embodiment 2

Embodiment 2 also refers to UAV specific CHO configuration. In Embodiment 2, for a case that a source node of a UE knows the UE's planned flight path in advance, e.g., based on the planned flight path reported by the UE, CHO execution condition can be a flight path based condition (e.g., one or more location coordinate(s) of the UE). When the UE's location coordination(s) is within a geographical area, e.g., a configured specific range of location coordinates, the UE executes the CHO procedure, e.g., the UE starts synchronization with the target cell, or, the UE performs RACH procedure towards the target cell. For example, the configured specific range of location coordinates may include multiple location coordinates, may include multiple longitude information and/or latitude information and/or height information, or may include grid information.

In Embodiment 2, a candidate cell can be configured with at least one execution condition, and one execution condition includes one or more trigger conditions. The one or more trigger conditions can be a flight path based condition (e.g., one or more location coordinate(s) of the UE). For example, for candidate cell 1, two execution conditions, e.g., location coordinate 1 and location coordinate 2, are configured simultaneously.

In Embodiment 2, in one way, a flight path based condition (e.g., one or more location coordinate(s) of the UE) may be configured by a source node of the UE.

In Embodiment 2, a flight path based condition can be set as a CHO execution condition in combination with a RRM based condition, i.e., a CHO execution condition for a candidate cell can include both a flight path based condition and a RRM based condition. For one cell during one CHO procedure, it can be configured as the CHO candidate cell with “different flight path based conditions” and/or “different RRM based conditions” independently.

For example, for one candidate cell, one or more location coordinate based conditions can be configured to a UE simultaneously. Accordingly, different RRM based conditions can be configured which are associated with “different location coordinate based conditions”.

In Embodiment 2, taking candidate cell A as an example, when it is configured with “CondEvent Location coordinates #1” and “CondEvent Location coordinates #2” by a network node, the network node can configure different RRM based conditions for candidate cell A. That is, “a RRM based condition for candidate cell A which is configured with CondEvent Location coordinates #1” may be different from “a RRM based condition for candidate cell A which is configured with CondEvent Location coordinates #2”. For example, candidate cell A can be configured with “CondEvent Location coordinates #1 and CondEvent A3” and “CondEvent Location coordinates #2 and CondEvent A5”, simultaneously during one CHO procedure.

In Embodiment 2, a UE may be configured with different CHO execution conditions. In an example, at least a height based condition and at least a flight path based condition together for at least a candidate cell may be configured to the UE as CHO execution conditions. In another example, at least a height based condition, at least a flight path based condition, and at least a RRM based condition together for at least a candidate cell may be configured to the UE as CHO execution conditions.

### Embodiment 3

Embodiment 3 refers to UAV specific CHO evaluation and execution. In Embodiment 3, when “height (e.g., CondEvent H1, CondEvent H2, or CondEvent H3) and RRM (e.g., CondEvent A3, CondEvent A4, or CondEvent A5) based conditions” or “flight path and RRM based conditions” are configured:
Option 1: When a height based (or a flight path based) condition for one or more candidate cells is satisfied, a UE starts to evaluate whether a corresponding RRM based condition for one or more candidate cells is satisfied. The UE only judges whether CondEvent A3, CondEvent A4, or CondEvent A5 is satisfied after a height based condition (or a flight path based condition) is satisfied.
Option 1 is especially beneficial for the case that when configuring CHO configurations, the height based condition (or the flight path based condition) and a candidate cell is one-to-multiple mapped.
Option 2: The order to evaluate a height based condition (or a flight path based condition) and a RRM based condition is up to a UE's implementation. For example:
(1) the UE starts to evaluate a RRM based condition when a height based condition (or a flight path based condition) is satisfied; or
(2) the UE starts to evaluate a height based condition (or a flight path based condition) when the RRM based condition is satisfied; or
(3) the UE starts to evaluate the RRM based condition and the height based condition (or the flight path based condition) simultaneously, e.g., when CHO configurations are received by the UE; or
(4) the UE starts to evaluate the RRM based condition when both the height based condition and the flight path based condition are satisfied; or
(5) the UE starts to evaluate the height based condition when both the RRM based condition and the flight path based condition are satisfied; or
(6) the UE starts to evaluate the flight path based condition when both the RRM based condition and the height based condition are satisfied; or
(7) the UE starts to evaluate the height based condition when the flight path based condition is satisfied; or
(8) the UE starts to evaluate the flight path based condition when the height based condition is satisfied.
(9) The UE starts to evaluate the RRM based condition, the flight path based condition, and the height based condition simultaneously, e.g., when CHO configurations are received by the UE.
Option 2 is especially beneficial for the case that when configuring CHO configurations, the height based condition (or the flight path based condition) and a candidate cell is one-to-one mapped.

In Embodiment 3, when both a height based condition and a RRM based condition for one candidate cell are satisfied, or when both a flight path based condition and a RRM based condition for one candidate cell are satisfied, this candidate cell can be selected as the target cell, and a CHO procedure can be executed, e.g., the UE starts synchronization with the target cell, or, the UE performs a RACH procedure towards the target cell For example, for candidate cell 1 which is configured with CondEvent H1 as the height based condition and CondEvent A3 as the RRM based condition, when the height of the UE is above a threshold configured for CondEvent H1, and candidate cell 1 becomes offset (i.e., the offset is configured for CondEvent A3) better than a source cell, the UE can execute the CHO procedure, e.g., the UE access or handover to candidate cell 1.

In Embodiment 3, for a case that each of multiple candidate cells satisfies its corresponding CHO execution conditions independently, a target cell selected by the UE from these multiple candidate cells can be a candidate cell where the UE is moving towards, or can be a candidate cell which is nearest to next destination (for example, based on the planned flight path if any), or can be a candidate cell whose quality is getting better during the evaluation TTT timer which is configured as CHO configurations and is used for evaluating whether the at least one execution condition for the at least one candidate cell of the CHO procedure is satisfied.

### Embodiment 4

Embodiment 4 refers to MRO for mobility in UAV In Embodiment 4, for a MRO purpose, to avoid a handover failure case or a RLF case and to enable a network node to configure proper mobility configurations (e.g., CHO execution condition(s), candidate cell list(s), and/or mobility parameters(s)), the UE can log or record or store and report some assistance information to the network node, including at least one of the following:
UE's height information (or location coordinates) when a source RLF or a handover failure or a CHO execution failure occurs;
UE's height information (or location coordinates) when CHO configurations are received by the UE;
UE's height information (or location coordinates) when a CHO procedure is executed;
an indication to indicate whether a height based (or flight path based) condition is satisfied when a source RLF or a handover failure or a CHO execution failure occurs;
UE's height information (or location coordinates) when a CHO recovery procedure (e.g., the UE handovers to a candidate cell when this candidate cell is selected after a source RLF or a handover failure or a CHO execution failure occurs) is successful or failed; or
an indication to indicate whether the selected candidate cell for a CHO recovery procedure satisfies its height based (or its flight path based) condition.

After a RLF or a handover failure or a CHO execution failure occurs, the UE may perform a RRC re-establishment procedure or a CHO recovery procedure. The RRC re-establishment network node may be a source node or a target node or a non-target candidate node or another node. Then, in Option 1, the RRC re-establishment network node may transmit the assistance information received from the UE to the source node. In Option 2, the RRC re-establishment network node may transmit the assistance information received from the UE to the target node, and then, the target node may transmit the assistance information to the source node.

In Embodiment 4, when the network node receives the above assistance information, it can modify CHO configurations (e.g., height based (or flight path based) condition, or a candidate cell list).

In Embodiment 4, for a MRO purpose, to avoid a near-failure successful handover, and to enable the network to configure proper mobility configurations (e.g., a CHO execution condition, a candidate cell list, and/or mobility parameter(s)), a SHR can be logged or recorded or generated or stored, and then the SHR can be reported to the network node.

In Embodiment 4, an UAV specific triggering condition for a SHR can be considered, e.g., a UE's height is higher than a configured threshold, the UE's height is lower than a configured threshold, or the UE is located within a geographical area e.g., a specific range of location coordinates. For example, the specific range of location coordinates may include multiple location coordinates, may include multiple longitude information and/or latitude information and/or height information, or may include grid information.

The UAV specific triggering condition for a SHR can be generated by the source node, and then, the source node sends the UAV specific triggering condition for a SHR to the UE via the RRC message.

Or, the UAV specific triggering condition for a SHR can be generated by a candidate node, then, the candidate node sends the UAV specific triggering condition for a SHR to the source node, and source node sends the UAV specific triggering condition for a SHR to the UE via the RRC message. For example, an indication (e.g., “generate triggering condition for a SHR”) can be included in a HO Request message, to indicate the candidate node to generate UAV specific triggering condition for a SHR. The indication can be an explicit indication. Based on this indication, the candidate node generates UAV specific triggering condition for a SHR. The UAV specific triggering condition for a SHR can be included in a HO Request ACK message, and the source node may send the UAV specific triggering condition for a SHR to the UE via RRC message(s).

When at least one triggering condition for SHR is satisfied, the UE can generate a SHR and send the SHR to the target node. The target node can send the information included in the SHR to the source node.

For example, a SHR can include information as below:
(1) UE's height information (or location coordinate(s)) of the UE when a CHO procedure is executed;
(2) UE's height information (or location coordinate(s)) of the UE when CHO configurations are received by the UE;
(3) UE's height information (or location coordinate(s)) of the UE when a CHO procedure is successful; and/or
(4) a cause value for the SHR, or a flag or an indication to indicate which triggering condition for logging or generating or storing the SHR is satisfied, e.g., a flag to indicate that the height is higher than a configured threshold.

In Embodiment 4, when the network node (a source node or a target node) receives the SHR, it can modify CHO configurations, e.g., a height based (or a flight path based) condition or RACH configurations, or the source node may send CHO configurations to the UE a bit earlier.

The method(s) of the present disclosure can be implemented on a programmed processor. However, controllers, flowcharts, and modules may also be implemented on a general purpose or special purpose computer, a programmed microprocessor or microcontroller and peripheral integrated circuit elements, an integrated circuit, a hardware electronic or logic circuit such as a discrete element circuit, a programmable logic device, or the like. In general, any device that has a finite state machine capable of implementing the flowcharts shown in the figures may be used to implement the processing functions of the present disclosure.

While this disclosure has been described with specific embodiments thereof, it is evident that many alternatives, modifications, and variations may be apparent to those skilled in the art. For example, various components of the embodiments may be interchanged, added, or substituted in the other embodiments. Also, all of the elements of each figure are not necessary for operation of the disclosed embodiments. For example, those having ordinary skills in the art would be enabled to make and use the teachings of the disclosure by simply employing the elements of the independent claims. Accordingly, embodiments of the disclosure as set forth herein are intended to be illustrative, not limiting. Various changes may be made without departing from the spirit and scope of the disclosure.

In this document, the terms “includes,” “including,” or any other variation thereof, are intended to cover a non-exclusive inclusion, such that a process, method, article, or apparatus that includes a list of elements does not include only those elements but may include other elements not expressly listed or inherent to such process, method, article, or apparatus. An element proceeded by “a,” “an,” or the like does not, without more constraints, preclude the existence of additional identical elements in the process, method, article, or apparatus that includes the element. Also, the term “another” is defined as at least a second or more. The term “having” and the like, as used herein, are defined as “including.

1. A user equipment (UE) for wireless communication, comprising:
at least one memory; and
at least one processor coupled with the at least one memory and configured to cause the UE to:
receive configuration information of a conditional handover (CHO) procedure regarding at least one of a height based condition or a flight path based condition;
evaluate whether at least one execution condition for at least one candidate cell of the CHO procedure is satisfied, wherein the at least one execution condition includes the at least one of the height based condition or the flight path based condition; and
execute the CHO procedure when the at least one execution condition is satisfied.

2. The UE of claim 1, wherein the height based condition or the flight path based condition is configured for a candidate cell.

3. The UE of claim 1, wherein the at least one execution condition for a candidate cell of the CHO procedure includes one or more trigger conditions, wherein the one or more trigger conditions are the height based condition or the flight path based condition.

4. The UE of claim 1, wherein two or more execution conditions for a candidate cell of the CHO procedure are configured simultaneously to the candidate cell.

5. The UE of claim 1, wherein the at least one processor is further configured to cause the UE to receive configuration information of the CHO procedure regarding a radio resource management (RRM) based condition.

6. The UE of claim 5, wherein the at least one execution condition for the at least one candidate cell of the CHO procedure further includes the RRM based condition, and wherein the CHO procedure is executed upon both the RRM based condition and the at least one of the height based condition or the flight path based condition when the at least one candidate cell of the CHO procedure is satisfied.

7. The UE of claim 6, wherein, during evaluating whether the at least one execution condition for the at least one candidate cell of the CHO procedure is satisfied, the at least one processor is further configured to cause the UE to:
evaluate the RRM based condition when the height based condition or the flight path based condition is satisfied;
simultaneously evaluate the RRM based condition and the height based condition in order to evaluate the height based condition when the RRM based condition or the flight path based condition is satisfied;
simultaneously evaluate the RRM based condition and the flight path based condition; or
evaluate the flight path based condition when the RRM based condition or the height based condition is satisfied.

8. The UE of claim 1, wherein the at least one processor is further configured to cause the UE to:
store height related assistance information; and
transmit the height related assistance information.

9. The UE of claim 8, wherein the height related assistance information includes at least one of:
information indicating whether the height based condition is satisfied when a failure occurs, wherein the failure includes at least one of: a source radio link failure (RLF), a handover failure, or a CHO execution failure;
information indicating whether the flight path based condition is satisfied when the failure occurs;
height information of the UE when the failure occurs;
a location coordinate of the UE when the failure occurs;
the height information of the UE when a CHO recovery procedure is successful;
the height information of the UE when the CHO recovery procedure fails;
the location coordinate of the UE when the CHO recovery procedure is successful;
the location coordinate of the UE when the CHO recovery procedure fails;
information indicating whether a selected candidate cell for the CHO recovery procedure satisfies the height based condition; or
information indicating whether the selected candidate cell for the CHO recovery procedure satisfies the flight path based condition.

10. The UE of claim 1, wherein the at least one processor is further configured to cause the UE to receive configuration information regarding a triggering condition for logging a successful handover report (SHR).

11. The UE of claim 10, wherein the triggering condition for logging the SHR includes at least one of:
height information of the UE being higher than a first threshold;
the height information of the UE being lower than a second threshold; or
a location coordinate of the UE being located within a location coordinate range.

12. The UE of claim 10, wherein the at least one processor is further configured to cause the UE to:
generate the SHR, in response to the triggering condition for logging the SHR being satisfied; and
transmit the SHR.

13. The UE of claim 10, wherein the SHR includes at least one of:
height information of the UE when the CHO procedure is executed;
the height information of the UE when the CHO procedure is successful; or
information indicating which triggering condition for logging the SHR is satisfied.

14. A source network node for wireless communication, comprising:
at least one memory; and
at least one processor coupled with the at least one memory and configured to cause the source network node to:
generate configuration information regarding at least one execution condition for at least one candidate cell of a conditional handover (CHO) procedure of a user equipment (UE), wherein the at least one execution condition includes at least one of a height based condition or a flight path based condition; and
transmit the configuration information to the UE.

15. A network node for wireless communication, comprising:
at least one memory; and
at least one processor coupled with the at least one memory and configured to cause the network node to:
transmit a first height based neighbor cell list of the network node via to a source network node of a user equipment (UE); and
receive a second height based neighbor cell list of the source network node from the source network node; or
receive an indication from the source network node, wherein the indication indicates the network node to generate first information regarding at least one execution condition for at least one candidate cell of a conditional handover (CHO) procedure of the UE, wherein the at least one execution condition includes at least one of a height based condition or a flight path based condition.

16. A processor for wireless communication, comprising:
at least one controller coupled with at least one memory and configured to cause the processor to:
receive configuration information of a conditional handover (CHO) procedure regarding at least one of a height based condition or a flight path based condition;
evaluate whether at least one execution condition for at least one candidate cell of the CHO procedure is satisfied, wherein the at least one execution condition includes the at least one of the height based condition or the flight path based condition; and
execute the CHO procedure when the at least one execution condition is satisfied.

17. The processor of claim 16, wherein the height based condition or the flight path based condition is configured for a candidate cell.

18. The processor of claim 16, wherein the at least one execution condition for a candidate cell of the CHO procedure includes one or more trigger conditions, wherein the one or more trigger conditions are the height based condition or the flight path based condition.

19. The processor of claim 16, wherein two or more execution conditions for a candidate cell of the CHO procedure are configured simultaneously to the candidate cell.

20. The processor of claim 16, wherein the at least one controller is further configured to cause the processor to receive configuration information of the CHO procedure regarding a radio resource management (RRM) based condition.
